(19) United States
(12) Patent Application Publication
(10) Pub. No.: US 2024/0183396 A1
(43) Pub. Date: Jun. 6, 2024

(54) BEARING-ASSEMBLY COMPONENT AND METHOD FOR MANUFACTURING SUCH A BEARING-ASSEMBLY COMPONENT

(71) Applicant: AKTIEBOLAGET SKF, GOTEBORG (SE)

(72) Inventor: Thilo VON SCHLEINITZ, Schweinfurt (DE)

(21) Appl. No.: 18/514,490

(22) Filed: Nov. 20, 2023

(30) Foreign Application Priority Data
Dec. 2, 2022 (DE) 102022213020.0

(51) Int. Cl. F16C 33/12; F16C 17/02; F16C 33/14

(52) U.S. Cl. CPC F16C 33/12; F16C 17/02; F16C 33/14; F16C 2223/02

(57) ABSTRACT

A first bearing assembly component that is configured to be connected to a second bearing assembly component, the first bearing assembly component having a mechanically finished contact surface configured to frictionally engage a counter-contact surface of the second bearing assembly component to secure the first bearing assembly component to the second bearing assembly component. The contact surface includes an acid-formed reaction layer having a coefficient of friction greater than a coefficient of friction of a material of the first bearing assembly component without the reaction layer. Also a method of forming the first bearing assembly element and a method of forming a bearing assembly from the bearing assembly components.

### CROSS-REFERENCE

This application claims priority to German patent application no. 10 2022 213 020.0 filed on Dec. 2, 2022, the contents of which are fully incorporated herein by reference.

### TECHNOLOGICAL FIELD

The present disclosure is directed to a bearing assembly component and a method for manufacturing a bearing assembly component which component is configured to be connected to another bearing assembly component in a friction-fit manner.

### BACKGROUND

In bearing assemblies, it can be necessary to connect various components, such as, for example, a bearing ring to a shaft or a housing, in a rotationally fixed and displacement-resistant manner. This can be effected in different ways.

For example, the inner ring can be press-fitted onto a shaft, or the inner ring can heated so that it expands somewhat and then allowed to cool such that it shrinks onto the shaft. In such construction methods the range of acceptable pressures produced by the ring against the shaft is limited. On the one hand it must not overload the materials, and on the other hand it must still be possible to assemble. The thermal loadability of the heat-treated steel is also strictly limited. Occasionally it can occur, for example, in wind-power applications, that despite a friction-fit connecting of a ring of the rolling-element bearing or plain bearing to the surrounding construction (e.g., housing or shaft), a so-called ring migration occurs. The movement can occur as axial displacement or as slow rotation or as a combination of both. Here the affected ring shifts very slowly in its position. Such a ring migration is unwanted since it can adversely affect the correct positioning of the bearing and also cause damage such as fretting corrosion to the seat. Furthermore, a bearing may be intended for a specific mounting position, i.e., a ring may require a position that is either absolutely fixed or fixed relative to its surroundings (e.g., relative to a rotating shaft) due to connections, lubrication holes, or similar non-circularly symmetrical design features, and this position must not change after it has been established.

If a positive connection of the ring to the corresponding component is not possible by means of bolts, feather keys, axial pressure covers or similar elements, it may be necessary to use a frictional connection designed in such a way that a sufficiently large frictional force is produced, in particular, a frictional force which is sufficiently large to prevent the ring migration described above. In this context, the friction force is determined by the friction value, assuming a maximum normal force or contact pressure force.

Typically the friction between two components of a bearing assembly can be increased by increasing the friction value (also called friction coefficient or coefficient of friction) of at least one contact surface of the two components. A known solution for the friction increase is the application of layers of zinc. However, in spray processes, such as, for example, flame spraying, the layer accuracies are usually not sufficient to achieve a defined overlap and fit between, for example, the inner ring and shaft. A thus-required mechanical post-processing of the zinc surfaces is expensive and problematic due to the lubrication effect during the grinding. Since not the shaft but rather the ring is coated, with smaller rings it can also be difficult to carry out a spraying at the required nearly vertical angle to the surface of the bore. Furthermore, it is necessary to mask the remaining ring surfaces. The effort necessary for this purpose, which in addition to the masking includes sand blasting, spraying, and cleaning, is very high.

In galvanic zinc-plating methods, the ring is immersed in a bath, which can prove impossible in the case of large rolling-element bearings due to the workpiece size. Furthermore, functional surfaces such as the raceway must be extensively protected from chemical and electrolytic influence. In mechanical zinc-plating methods, there are also significant implementation problems in coating a large ring area by area.

A different known solution for increasing friction is the use of zinc lacquers or friction lacquers that can additionally contain particles of hard material. These also include coating methods in which zinc flakes are fixed on the surface with a lacquer-like binding agent. If such lacquers are used in immersion or spray methods, the above-described problems of the coating only needed in the bore of the inner ring, i.e., regionally, or of the workpiece size can occur. Although some lacquers can be applied in the bore of a ring without problems, they have a layer thickness tolerance of, for example, 35+10/−5 μm, i.e., 15 μm thickness fluctuation. However, for establishing a correct coverage and press fit, such a thickness fluctuation is too high. In addition, lacquer systems only very poorly tolerate the shear forces of a push on (press fitting one element onto the other).

Alternatively, instead of a press fit, the components can be adhered to each other. However, such an adhesive connection has the disadvantage that in the event of damage, it can be dismantled only with difficulty for the bearing exchange. There is also the risk that the thin-liquid adhesive reaches unintended locations, or even into the bearing interior.

A further possibility for increasing friction in order to connect two bearing assembly components to each other comprises a blasting of the ring bore. With sandblasting, or blasting with, for example, angular chilled cast iron or abrasive grain, the surface is roughened, and the friction thereby increased. Disadvantages are also associated with this method. Thus, it is actually undesirable to bring a rolling-element bearing ring into contact with blasting material since a hard grain that remains unnoticed on the ring can lead to progressive bearing damage if it finds its way in the interior and raceway contact of the finished rolling-element bearing. In addition, the blasting also requires a costly masking of the surfaces not to be processed. The blasting furthermore leads to material removal. This results in a decrease in the roundness and dimensional accuracy of the bore and possibly a critical change compared to the desired dimensional overlap and fit. Finally, the blasting is also effected in principle outside the fine processing or assembly areas and therefore requires a separate ring transport, possibly even to external cooperation partners. It is even possible that the blasting can decrease the friction forces instead of increasing them because, due to material removal and shape defects caused by the blasting, the normal forces may decrease such that micro-toothing and/or structures that contribute to a frictional engagement no longer engage as effectively with a counter-contact surface.

### SUMMARY

It is therefore an aspect of the present disclosure to provide a bearing assembly component that is connectable to another bearing assembly component reliably and in a simple manner with increased friction forces and thus with increased security against ring migration.

In the following, “bearing assembly” is understood to mean any type of assembly of a bearing, such as a rolling-element bearing or plain bearing, in a housing or on a shaft, but also a shaft-hub connection. Here a surface of a bearing assembly component, such as, for example, an inner ring or outer ring of a bearing, can have a contact surface in contact with a counter-contact surface of a further bearing assembly component, such as, for example, a shaft or a housing. The contact can be effected radially, i.e., via outer diameter or inner diameter, but also axially, i.e., via the lateral end surfaces. Here a bearing assembly component can be any type of component that is to be connected to a further bearing assembly component in a positionally fixed manner, and, as already mentioned, can be a component of a bearing, such as a bearing ring, a housing, a shaft, or a hub, or similar. In contrast to welding or adhesive connections, the bearing assembly components are preferably releasably connected to each other, i.e., if needed, for example, with a possibly necessary bearing exchange, the two components can be released from each other again in a non-destructive manner.

The bearing assembly component described here is connectable in a friction-fit manner by a contact surface to a counter-contact surface of a further bearing assembly component. Due to this friction-fit connection, the bearing assembly component can be connected to the further bearing assembly component in a positionally fixed manner. The two bearing assembly components are preferably non-destructively releasable from each other again when necessary.

To achieve this frictionally engaged, positionally stable connection, the surface of the contact surface has a reaction layer formed on the surface of the contact surface with acid. The reaction layer is designed to increase the coefficient of friction of the surface of the contact surface with respect to the material of the contact surface. This means that the reaction layer has a higher coefficient of friction (also called friction coefficient or friction value) than the coefficient of friction of the surface or of the material of the contact surface without the reaction layer. In addition to the increased coefficient of friction, the reaction layer can, in particular in a manner depending on the acid used, also include a chemical roughening, for example, in the form of etching pits or pittings. In addition to the friction fit, a kind of micro-interference fit can therefore be provided by such a chemical roughening, which is explained in more detail below.

The material of the contact surface, and in particular of the entire bearing component, is preferably comprised of metal, preferably of steel. On the metallic base material of the contact surface, an acid is applied that reacts with the base material and generates a reaction layer by etching or corroding.

In contrast to previously known methods, in which additional layers such as a zinc layer or zinc lacquer or friction lacquer have been applied onto the contact surface of the component or in which the component has been roughened by sandblasting, in the bearing assembly component proposed here, the surface of the contact area includes a reaction layer directly introduced into the material of the contact surface by a material transformation of the available surface. An additional material applied onto the contact surface in the sense of a coating is not present. Depending on the acid used, the material transformation of the surface typically results in a matte gray surface, whereby the acid can leach iron from the surface and accumulate alloying elements and carbides contained in the material at the surface. This matte grey corrosion surface usually has a lower hardness than the hardened rolling-element bearing steel and an increased coefficient of friction in comparison to the hardened rolling-element bearing steel. The reaction layer is generated in particular by acid corrosion. Here it is a thin surface modification, in particular in a range of less than 2 micrometers. Here the top layer of the contact surface is not etched away, but rather only a reaction layer, i.e., a transformation of the surface, is generated.

The affinity and adhesion of two surfaces, in this case the contact surface and the counter-contact surface, is an interplay of adhesion forces, surface energy, hardness, and roughness, as well as roughness profile. A roughness profile with many small elevations and peaks can both interlock into a similar counter-profile and be pressed into a smooth or sufficiently soft counter-surface. Independent thereof, however, due to their physical and chemical properties, smooth surfaces can also have higher or lower adhesion and friction. In most cases, these are surfaces with high surface energy, which are also used as an adhesion primer under coatings, for example, which then exhibit high friction against similar or other surfaces with likewise high surface energy. For the friction increase, pre-treatment processes are thus of interest for lacquers and coatings, which pre-treatment processes increase the surface energy and possibly also influence the surface structure and increase the roughness.

Due to the acid treatment of the (steel) surface, three different friction-increasing effects can thus occur simultaneously and in an overlapping manner. First, in pure consideration of friction value, the reaction layer has a high friction due to high surface energy. Second, the reaction layer can have a reduced hardness and thus allow the roughness of a counter-contact surface to penetrate into the soft reaction layer and make a micro-interference fit. Thirdly, any corrosion pits or recesses or pittings that may have been created can also make it easier for a mating contact surface with a suitable roughness profile to clamp the roughness peaks.

As mentioned above, it should be noted that the positionally fixed connection between the contact surface of the bearing assembly component and the counter-contact surface is achieved primarily by a friction fit. Here “friction fit” means that a retaining force with the counter-contact surface is generated purely by the contact force and the friction value of the contact surface. As already explained, the friction fit is improved by the reaction layer, which has a higher coefficient of friction than the base material of the contact surface or of the bearing assembly component. In addition to the friction fit, however, a micro-interference fit can also be achieved by the reaction layer. This means that the generated friction fit between the contact surface of the bearing assembly component and the counter-contact surface can at least partially comprise an interference fit on the micro-level. This micro-interference fit constitutes an actively sought interlocking in the micrometer and sub-micrometer range. In the bearing assembly component described here, this interlocking of the contact surface and of the counter-contact surface at the micro-level can be actively supported by the soft reaction layer being able to make possible a penetrating of the counter-roughness, i.e., of the rougher counter-contact surface.

As described above, the reaction layer or conversion layer is generated by applying an acid onto the contact surface. For example, such a conversion layer can be comprised of iron phosphate (so-called non-layer-forming surface modification) when phosphoric acid is used on steel. Other acids in turn dissolve iron, but not all the other components of the steel, so that, for example, carbide or alloy elements remain present at the surface.

For the reaction layer described herein, acids, such as, for example, nitric acid, carboxylic acids (such as, for example, oxalic acid), or phosphoric acid can be used in particular, which do not corrode a bright steel surface and make it bright like hydrochloric acid does but rather make it grey. These grey corrosion layers, which can result from conversion reactions or non-uniform dissolving of the steel components, all have a dull, smooth character and a reduced hardness compared to hardened steel. In this way, the friction is increased in comparison to the counter-contact surface.

Such grey corrosion layers can be generated with a variety of acids. For example, carboxylic acid, in particular oxalic acid, can be used, whereby the surface of hardened rolling-element bearing steel is transformed to grey (among other compounds, iron oxalate). Furthermore, nital etching can be used. Nital etching uses alcoholic nitric acid, partly with addition of further acids.

The reaction layer preferably has a hardness that is lower than the hardness of the material of the contact surface. Hardened rolling-element bearing steel usually has a hardness of approximately 60 to 62 HRC. The reaction layer reduces the hardness of the surface of the contact surface, but only for the very low thickness of this reaction layer. The material below this reaction layer still has the hardness of the base material of the bearing assembly component. A measuring with Rockwell methods is thus practically not possible, and instead small-load methods or nanoindenters are required. The reduction of the micro-hardness of the reaction layer compared to the untreated surface is essential. With conversion of the hardness of the reaction layer into the HV and HRC scale, the hardness of the reaction layer here is preferably less than 700 HV or 60 HRC, and in particular less than 500 HV or 50 HRC.

In addition to the increased coefficient of friction, the reaction layer can have recesses relative to the surface of the contact surface. Here no significant amount of surface material is removed, as is the case, for example, with sand blasting. Instead, the material of the surface of the contact surface is dissolved or converted by an applied acid, and here optionally provided with small local corrosion pits (pittings). The corrosion generates small recesses relative to the surface of the contact surface, since, as described above, a part of the material, such as, for example, iron components or certain local alloy components, is dissolved or converted. The corrosion does not work like the shining and smoothing with acids, wherein a chemical polishing and a bright shiny surface arises due to surface corrosion and targeted removal of the roughness peaks. The corrosion used here does not lead to a smoothed, but rather to a roughened, surface, with the result that the contact surface has a higher roughness and coefficient of friction than would be the case without the reaction layer with its possibly present small recesses. However, the reaction layer does not constitute a comprehensive change of the contact surface, i.e., no cracks or micro-structure damages arise that could lead to early wear or failure of the bearing assembly component.

Generating the reaction layer by an acid also has the advantage that the corresponding contact surface is finished mechanically; that is, the dimensions of the contact surface are already in their final state. The dimensions of the contact surface or of the corresponding bearing assembly component do not change significantly due to the reaction layer. However, due to the reaction layer, the friction is increased since a soft reaction layer with high coefficient of friction is generated on the finished contact surface.

Preferably only the portion of the contact surface that is to come into contact with a counter-contact surface of a further component is provided with such a reaction layer. Other surfaces of the bearing assembly component preferably remain free of such a reaction layer. In one variant it is also possible that the entire contact surface is not provided with such a reaction layer, but rather there are regions of the contact surface with a reaction layer and regions without a reaction layer. This has the advantage that there are also, in addition to the area with reaction layer, areas which have an exactly fitting surface without any modification, as produced in advance by mechanical processing, for example by grinding. Furthermore, on the areas without reaction layer, a black oxide layer or similar can be provided. Such a black oxide layer would be removed again by the application of the acid required for the reaction layer.

As already described above, the production of the reaction layer is not a machining process. Thus there is no particle abrasion and no contamination of the bearing assembly, especially of adjacent running surfaces. Unlike, for example, with sand blasting, an already correctly ground bore or other contact surface is furthermore not distorted in shape and dimension. The overlap of the press fit remains precisely predeterminable, and only the coefficient of friction is adjusted.

In particular in the case in which, in addition to the increased coefficient of friction, the reaction layer also includes recesses or pittings that lead to a chemical roughening of the surface of the contact surface, according to a further embodiment, the regions of the reaction layer have a defined superordinate pattern. For example, the reaction layer is designed such that a plurality of etched regions, for example, stripes, are provided, that are arranged in their alignment such that they do not extend in the circumferential direction, but rather obliquely or perpendicularly with respect to the circumferential direction. If a chemical roughening is present, in particular in the case of a rotating ring a migration can be counteracted by such an axial extension or essentially axial extension of the structure, since the structure extends in a different direction than the rotation of the ring. If no chemical roughening is present, but rather only a reaction layer with high coefficient of friction, the direction configuration has no significant importance.

According to a further aspect, a method is provided for manufacturing a bearing assembly component as described above. The method includes the following steps: providing a bearing assembly component with a mechanically finished contact surface, and generating a reaction layer on the finished contact surface, wherein the reaction layer is designed to increase the coefficient of friction of the surface of the contact surface in relation to the material of the contact surface.

As already explained above, a mechanically finished contact surface, i.e., a contact surface that has its final processing state in its dimensions and is already finally ground, is processed in order to obtain a reaction layer that increases the coefficient of friction of the base material or has a higher coefficient of friction than the base material of the contact surface. Due to this higher coefficient of friction of the reaction layer, the friction between the contact surface and a counter-contact surface increases so that a displacing or sliding of the contact surface relative to the counter-contact surface is prevented.

For this purpose the surface of the finished contact surface is transformed by acid. The step of the generating of the reaction layer can in particular comprise an application of an acid, for example, carboxylic acid, in particular oxalic acid, or phosphoric acid or nitric acid, onto the finished contact surface. The application can be effected by immersion into an acid bath, but also by spraying, or, particularly in the case of area-by-area application, by wiping or application using a cloth or sponge.

A grey corrosion layer is generated by the applied acid, as is already described above. The surface of the contact surface, which is comprised, for example, of hardened rolling-element bearing steel, is converted into grey. The conversion result is different depending on the acid used; with oxalic acid, for example, iron oxalate is created, with phosphoric acid, iron phosphate is created, with various other acids only a concentration zone of poorly dissolvable material components is created.

The reaction layer can also be generated as a black layer by acid cold blackening. Here, in addition to the etching by acid effect (preferably nitric acid), copper and selenium compounds are deposited onto the contact surface. Although the cold-blackened layer is still a reaction layer, additional heavy metals are embedded or deposited in a coloring manner, without a significant layer thickness (in the range of a plurality of micrometers) being produced. A blackening generated by cold blackening also has a high friction or a higher coefficient of friction than the base material of the contact surface.

In particular when processing large rings, it is important to use a very fast-acting acid mixture, which, for example, can be applied by a person equipped with protective clothing using a sponge. This has the advantage that the entire bearing assembly component need not be immersed in an acid bath, which can be difficult due to the component size, and which in the case of bearing rings would also act on the raceways, which should not be treated with aggressive acids.

As already explained, acid can be applied to the contact surface either by immersion or by manual wiping with a sponge or cloth. The action time of the acid required here of the acid on the surface is preferably less than 5 minutes.

In combination with rolling-element bearings, nital etching with an acid mixture is particularly suitable. The acid mixture used in the nital etching can in particular be an alcoholic nitric acid, sometimes with addition of further acids. The necessary action time of the nitric acid, as well as of the remaining acids, is only 30 to 90 seconds. A manual application is therefore easily implementable. Nital etching is even permitted for raceways, and is used there for abrasive burn testing. The acid mixture can therefore be a nitric acid mixture for abrasive burn testing. Such an acid mixture has the advantage that it works particularly quickly and has a particularly minimal harmful effect. At the same time, however, the coefficient of friction of the contact surface is increased by the generated reaction layer. Furthermore, the acid mixture can include copper and/or selenium. Such an acid mixture with copper and selenium proportions can be used in particular for cold blackening.

According to a further embodiment, the step of the generating of the reaction layer further comprises neutralizing the applied acid by applying an alkaline solution and/or by washing with water. Diluted caustic soda is suitable as an alkaline solution. Before the application of the acid, the contact surface can first be degreased, for example, with ethanol or acetone. With immersion methods for smaller workpieces, alkaline heat degreasing can also be considered. After the application of the acid and generation of the reaction layer, the surface can be neutralized with an aqueous alkaline solution and dried. The treated contact surface, which now has the reaction layer, can then be preserved, for example, with oil without filming agents or with drying preservatives in order to not unnecessarily compromise the friction value of the surface. In this way, the contact surface can be protected without the achieved friction increase being compromised.

As already described above, the step of the generating of the reaction layer is preferably the last processing step on the contact surface. As already explained above, this has the advantage that the dimensions and contours of the contact surface are finished in their final form, and the reaction layer is generated on these final dimensions and contours. Preferably not only the contact surface, but rather the entire bearing assembly component, is finished when the reaction layer is generated.

The further steps, such as, for example, neutralizing or washing off and preserving, are part of the generating of the reaction layer, since the acid must be neutralized in order to prevent a further etching and subsequent corrosion of the surface. The preserving only serves for maintaining the reaction layer and itself does not constitute any more processing, in particular mechanical change, of the contact surface. In the choice of the preservation, substances such as greases can be avoided, for example, which are suited to further reduce the friction value. Conversely, an example of a possible preservative would be a thin, sprayed-on dry wax layer. An oil can also be used if it is wiped away again or degreased before the assembly.

The step of generating the reaction layer comprises in particular a removing of a blackening layer. Before the generating of the reaction layer or of the application of the acid required for this purpose, the bearing assembly component can be blackened. A possible blackening layer is instantly removed by the acid treatment for generation the reaction layer. In particular, rolling-element bearings are often blackened. Although the blackening is a conversion layer, it can have effects that promote rather than decrease slippage. Therefore it is advantageous that the generation of the reaction layer also removes, without a separate working process, such a blackened layer on the surface provided for friction-increase, for example the inner-ring bore. For example, if the bore of a blackened large bearing is wiped with an acid-soaked cloth, then the acid immediately removes the blackened layer and instead generates the friction-increasing reaction layer from the acid effect.

The method described above for producing the reaction layer can advantageously be used not only on a separately present bearing assembly component, but can also be used on an already completely installed bearing assembly component. This is in particular the case since the acid used can be applied manually and therefore only on the regions to be processed. In the case of generating a reaction layer in an inner-ring bore of a large bearing, the individual inner ring can be treated before installation, but even on already completely assembled large bearings, the inner-ring bore can be treated by wiping application of degreasing, acid, neutralization solution, and preservative.

In this way, it is theoretically also possible to generate the reaction layer in a defined pattern, as is already explained above. In this case, the acid is applied in the form and shape of the pattern to be achieved.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE FIGURE

FIG. 1 is a schematic perspective view of a bearing assembly component having a reaction layer according to an embodiment of the disclosure.

### DETAILED DESCRIPTION

In the following, identical or functionally equivalent elements are designated by the same reference numbers.

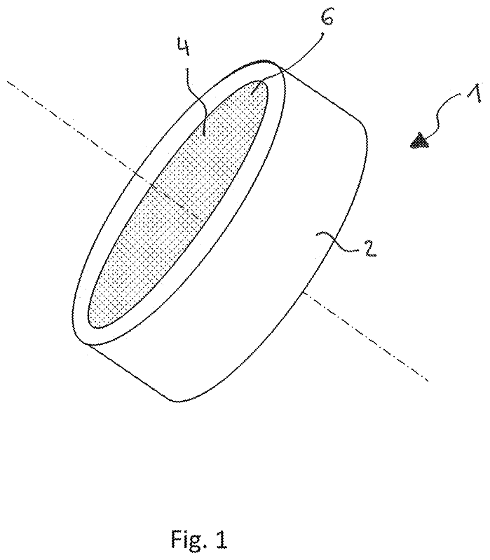

FIG. 1 shows a bearing assembly component 1. The bearing assembly component 1 can be a ring, as is shown here in FIG. 1, or can be any other bearing assembly component that is to be connected in a friction-fit manner to another bearing assembly component. For example, the bearing assembly component can be a part of a shaft-hub connection or be a part of a rolling-element or plain bearing, such as, for example, an inner or outer ring of such a bearing.

In the following, a bearing inner ring 1 is described as a the bearing assembly component. For example, the bearing inner ring 1 can be a tapered roller bearing or a ball bearing. However, it should be noted that the described features apply in an analogous manner for any type of bearing assembly component.

The bearing inner ring 1 includes an outer side 2 that can serve as a raceway for rolling elements or as a running surface of a plain bearing. Furthermore, the bearing inner ring 1 includes an inner bore 4 that serves as a contact surface that is to be connected in a friction-fit manner to a counter-contact surface, e.g., an outer diameter of a shaft.

For such a friction-fit connection, the contact surface 4 must have a surface that has a high enough friction value. As described below, this can be achieved by the contact surface 4 being partially or completely treated with an acid for generating a reaction layer.

In order to not significantly change the dimensions and contours of the finished contact surface 4, but to nonetheless obtain a good adhesion between the contact surface 4 and a counter-contact surface, a reaction layer 6 is located on the surface of the contact surface 4. The reaction layer 6 increases the friction of the surface of the contact surface 4, without, however, removing or adding surface material. Rather, by applying an acid, the material of the contact surface 4 forms a conversion or reaction layer, which, however, does not change the dimensions of the bearing inner ring 1, or at least changes the dimensions of the bearing inner ring by less than 2 micrometers. The fit accuracy of the bearing ring 1 is also maintained after the reaction layer 6 is generated.

The reaction layer 6 is formed by an acid, such as, for example, nitric acid or oxalic acid, being applied onto the material of the contact surface 4. Due to the action of the acid, a corrosion layer that constitutes the reaction layer 6 is formed in the surface of the contact surface 4. This has a higher friction value in comparison to the material of the contact surface. Due to the softer nature of the reaction layer 6, the contact surface 4 can connect to the counter-contact surface in a friction-fit manner.

The basic contour and the dimensions of the bearing ring 1 remain essentially present, so that in this respect no further post-processing of the bearing inner ring 1 is required. Optionally other surfaces of the bearing inner ring 1, such as, for example, the outer side 2, can be further processed. However, the production of the reaction layer 6 is preferably the last processing step, which can in particular also be carried out on an already installed bearing inner ring 1.

The reaction layer 6 can be fully etched on the contact surface 4, as is shown in FIG. 1. Alternatively, however, an edge region of the contact surface 4 can also remain free, or the reaction layer 6 can have a defined pattern.

In summary, due to the bearing assembly component described here, an easy-to-manufacture and cost-effective possibility is provided to improve the friction-fit connection between two bearing assembly components, without negatively influencing the dimensions and contours of the bearing assembly component.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing assembly components.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Bearing assembly component
2 Outer side
4 Inner bore/contact surface
6 Reaction layer

What is claimed is:

1. A first bearing assembly component configured to be connected to a second bearing assembly component, the first bearing assembly component having a mechanically finished contact surface configured to frictionally engage a counter-contact surface of the second bearing assembly component to secure the first bearing assembly component to the second bearing assembly component,
wherein the contact surface includes an acid-formed reaction layer having a coefficient of friction greater than a coefficient of friction of a material of the first bearing assembly component without the reaction layer.

2. The bearing assembly component according to claim 1,
wherein the reaction layer has a hardness lower than a hardness of the material of the first bearing assembly component beneath the reaction layer.

3. A bearing assembly comprising:
a first bearing assembly component according to claim 1, and
the second bearing assembly component mounted on the first bearing assembly component with the contact surface frictionally engaging the counter-contact surface.

4. The bearing assembly according to claim 3,
wherein the first bearing assembly component comprises a bearing inner ring, and
wherein the contact surface is a radially inner surface of the bearing inner ring.

5. A method for manufacturing a first bearing assembly component comprising:
mechanically finishing a contact surface of the first bearing assembly component, and
increasing a coefficient of friction of the contact surface by generating a reaction layer on the contact surface.

6. The method according to claim 5,
wherein generating the reaction layer comprises applying an acid to the mechanically finished contact surface.

7. The method according to claim 6,
wherein the acid includes a carboxylic acid, a phosphoric acid, or a nitric acid.

8. The method according to claim 6,
wherein the acid comprises oxalic acid.

9. The method according to claim 6,
wherein applying the acid comprises applying a nital etching acid mixture.

10. The method according to claim 6,
wherein applying the acid comprises applying an alcoholic nitric acid mixture suitable for abrasive burn testing.

11. The method according to claim 6,
wherein applying the acid comprises applying an acid mixture that includes copper and/or selenium.

12. The method according to claim 6,
including, after generating the reaction layer, applying an alkaline solution and/or water to the contact surface.

13. The method according to claim 6,
wherein generating the reaction layer occurs after a last mechanical processing of the contact surface.

14. The method according to claim 6,
including, after generating the reaction layer, drying and/or preserving the contact surface.

15. The method according to claim 6,
wherein the mechanically finished contact surface includes a blackening layer, and
wherein generating the reaction layer includes removing the blackening layer.

16. The method according to claim 6,
including mounting the first bearing assembly component to a second bearing assembly component with the contact surface in frictional engagement with a counter-contact surface of the second bearing assembly component.

17. The method of claim 16,
wherein the first bearing assembly component is a bearing inner ring.
